(19) United States
(12) Patent Application Publication
(10) Pub. No.: US 2008/0106891 A1
(43) Pub. Date: May 8, 2008

(54) Intelligent solar electric torch

(76) Inventor: Wen-Sung Lee, Taichung City (TW)

Correspondence Address: BACON & THOMAS, PLLC, 625 SLATERS LANE, FOURTH FLOOR, ALEXANDRIA, VA, 22314, US

(21) Appl. No.: 11/591,507

(22) Filed: Nov. 2, 2006

(51) Int. Cl. F21L 4/08; H02J 7/00; F21V 33/00

(52) U.S. Cl. 362/183; 320/101; 362/253

(57) ABSTRACT

A solar electric torch includes at least one solar cell made of amorphous silicon and provided thereon for converting light into electricity, a rechargeable battery installed therein for receiving the electricity from the solar cell and storing the same, a regulator arranged between the solar cell and the rechargeable battery for stabilizing the recharging and avoiding the transfer of the electricity to the solar cell from the rechargeable battery, a detector connected to the rechargeable battery for detecting the amount of the electricity stored in the rechargeable battery and a rate of the recharging, a microprocessor connected to the detector, a display mounted thereon and connected to the microprocessor for showing the amount of the electricity and the recharging rate and a lighting unit mounted thereon and connected to the microprocessor for illuminating.

### BACKGROUND OF INVENTION

1. Field of Invention

The present invention relates to an electric torch and, more particularly, to an electric torch that includes an amorphous silicon solar cell for recharging and a display for showing the amount of electricity stored therein.

2. Related Prior Art

An electric torch is used for illumination in the dark. An electric torch is an important tool for a guard while patrolling or a mechanic while checking or maintaining. Traditional electric torches are energized by traditional batteries. However, the traditional batteries cause serious pollution. Even when not used, the traditional batteries eventually run out of electricity and must be replaced with new ones.

To reduce the amount of batteries used and disposed of, rechargeable batteries are used. The rechargeable batteries can be recharged when they are not in use.

According to Kyoto Protocol, the emission of greenhouse gases should be controlled and new types of energy should be used instead of fossil fuel. Among the new types of energy, solar energy is preferred for some reasons. Firstly, there is an abundant supply of solar energy. Secondly, it is environmentally friendly. Thirdly, it can be used by ordinary people directly. Therefore, the solar energy industry is prospering, and the average complex growth rate of solar cells was 35% in the past five years. Solar cells have been used in electric torches such as disclosed in Chinese Utility Model Nos. 96202646.8, 02261464.8, 200420056756.X and 2004020103200.1.

There are amorphous silicon solar cells, mono-crystalline silicon solar cells and multi-crystalline silicon solar cells. Mono-crystalline silicon is generally made according to the Czochralski method. In the Czochralski method, silicon metal is molten in a quartz crucible, and a seed is implanted in the molten silicon metal so that mono-crystalline silicon is formed. Mono-crystalline silicon exhibits an excellent conversion rate.

The molecules of multi-crystalline silicon accumulate in more than one way. Multi-crystalline silicon includes many groups of molecules. In each group, the molecules accumulate in a direction. The groups however accumulate in different directions. Multi-crystalline silicon is made by melting silicon metal and casting the molten silicon metal. The multi-crystalline silicon is less expensive than mono-crystalline silicon.

Amorphous silicon includes molecules that accumulate randomly without following any rules. Amorphous silicon is generally made by plasma chemical vapor deposition. A layer of amorphous silicon is formed on a substrate made of glass for example. The thickness of the layer is about 1 micrometer. The substrate for amorphous silicon can be made of glass, ceramic or metal that is much cheaper than a substrate made of crystalline silicon. The ability to absorb light of amorphous silicon is about 500 times better than that of crystalline silicon. Amorphous silicon absorbs light in a cloudy day as well as crystalline silicon does in a sunny day. Therefore, in some places, it is better to use amorphous silicon than crystalline silicon.

Amorphous silicon is not used in electric torches due to difficulty in the production. Mono-crystalline or multi-crystalline silicon is used in electric torches. Such electric torches are inevitably expensive. In addition, such electric torches must be charged outdoor in sunny days, and this is inconvenient.

No electric torch, even it is equipped with a rechargeable battery, is able to tell how much electricity is available or how long it will take before it is packed with electricity.

Therefore, the present invention is intended to obviate or at least alleviate the problems encountered in prior art.

### SUMMARY OF INVENTION

It is an objective of the present invention to provide an inexpensive solar electric torch.

It is another objective of the present invention to provide a solar electric torch that can be recharged indoor or anywhere there is dim light.

It is still another objective of the present invention to provide a solar electric torch that shows how much electricity is available.

According to the present invention, a solar electric torch includes at least one solar cell made of amorphous silicon and provided thereon for converting light into electricity, a rechargeable battery installed therein for receiving the electricity from the solar cell and storing the same, a regulator arranged between the solar cell and the rechargeable battery for stabilizing the recharging and avoiding the transfer of the electricity to the solar cell from the rechargeable battery, a detector connected to the rechargeable battery for detecting the amount of the electricity stored in the rechargeable battery and a rate of the recharging, a microprocessor connected to the detector, a display mounted thereon and connected to the microprocessor for showing the amount of the electricity and the recharging rate and a lighting unit mounted thereon and connected to the microprocessor for illuminating.

Other objectives, advantages and features of the present invention will become apparent from the following description referring to the attached drawings.

### BRIEF DESCRIPTION OF DRAWINGS

The present invention will be described through detailed illustration of the preferred embodiment referring to the drawings.

FIG. 1 is a perspective view of a solar electric torch according to the preferred embodiment of the present invention.

FIG. 2 is another perspective view of the solar electric torch shown in FIG. 1.

FIG. 3 is a block diagram of a circuit used in the solar electric torch shown in FIG. 1.

FIG. 4 is a perspective view of a room where the solar electric torch shown in FIG. 1 is recharged by indoor light.

FIG. 5 is a perspective view of a room where the solar electric torch shown in FIG. 1 is recharged by sunlit.

FIG. 6 is a perspective view of a solar electric torch shown in FIG. 1 emitting light.

### DETAILED DESCRIPTION OF PREFERRED EMBODIMENT

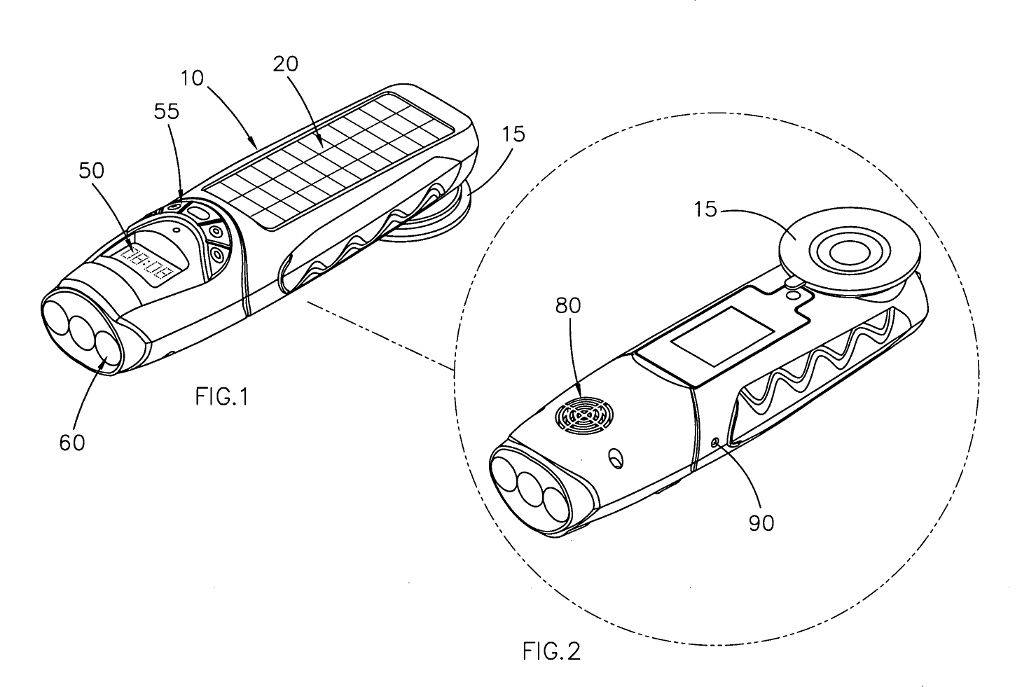

Referring to FIGS. 1 and 2, there is shown a solar electric torch 10 according to the preferred embodiment of the present invention. The solar electric torch 10 includes a plurality of solar cells 20 mounted on the top, a display 50 mounted on the top, a control panel 55 mounted on the top, a lighting unit 60 provided at an end, a charger 90 provided thereon and a speaker 80 provided thereon. The solar electric torch 10 is further provided with a sucking element 15 pivotally connected thereto.

The solar cells 20 are arranged in an array that is sometimes called a “solar panel.” The solar cells 20 are made of amorphous silicon. The solar cells 20 are inexpensive. Moreover, the solar cells 20 are excellent for converting solar energy into electricity, and can be used to recharge even where there is only dim light.

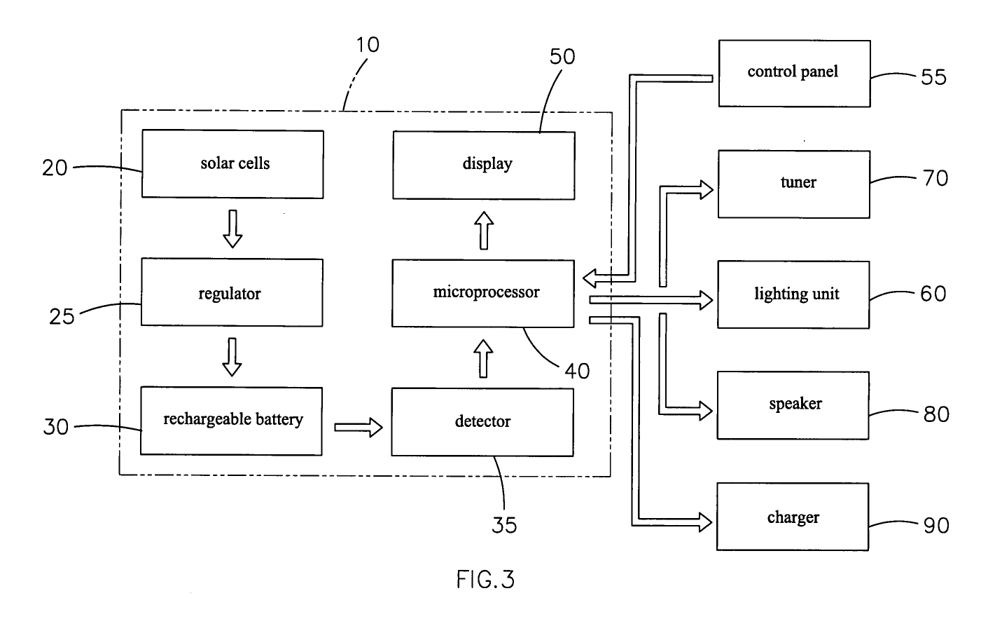

Referring to FIG. 3, the electric torch 10 includes a regulator 25 and a rechargeable battery 30 connected to the solar cells 20 through the regulator 25. The electricity is transferred to the rechargeable battery 30 from the solar cells 20 through the regulator 25. The regulator 25 is used for two purposes. Firstly, it stabilizes the recharging. Secondly, it avoids the transfer of electricity to the array of solar cells 20 from the rechargeable battery 30 when the conversion of light into electricity is inadequate. The rechargeable battery 30 may be any rechargeable battery such as a lithium battery, a nickel battery, a cadmium battery and a sodium battery.

A detector 35is connected to the rechargeable battery 30. The detector 35 is used to detect the amount of the electricity in the rechargeable battery 30 and therefore the recharging rate.

A microprocessor 40 is connected to the detector 35 so that the former receives signals from the latter. A display 50 is connected to the microprocessor 40. The display 50 may be any display such as a liquid crystal display (“LCD”) and a touch panel. The amount of the electricity in the rechargeable battery 30 and the recharging rate can be shown in the display 50.

A tuner 70 is connected to the microprocessor 40. The speaker 80 is connected to the microprocessor 40. Thus, a user can listen to radio with the solar electric torch.

The lighting unit 60 is connected to microprocessor 40 so that the lighting unit 60 illuminates under the control of the microprocessor 40.

The charger 90 is connected to the microprocessor 40 so that the charger 90 is used to recharge a battery for a mobile phone or another electric device under the control of the microprocessor 40.

The control panel 55 is connected to the microprocessor 40. The user operates the control panel 55 to control the display 50, the lighting unit 60, the tuner 70, the speaker 80 and the charger 90.

If the display 50 is a touch panel, the control panel 55 can be integrated with the touch panel so that the control panel 55 is part of the touch panel.

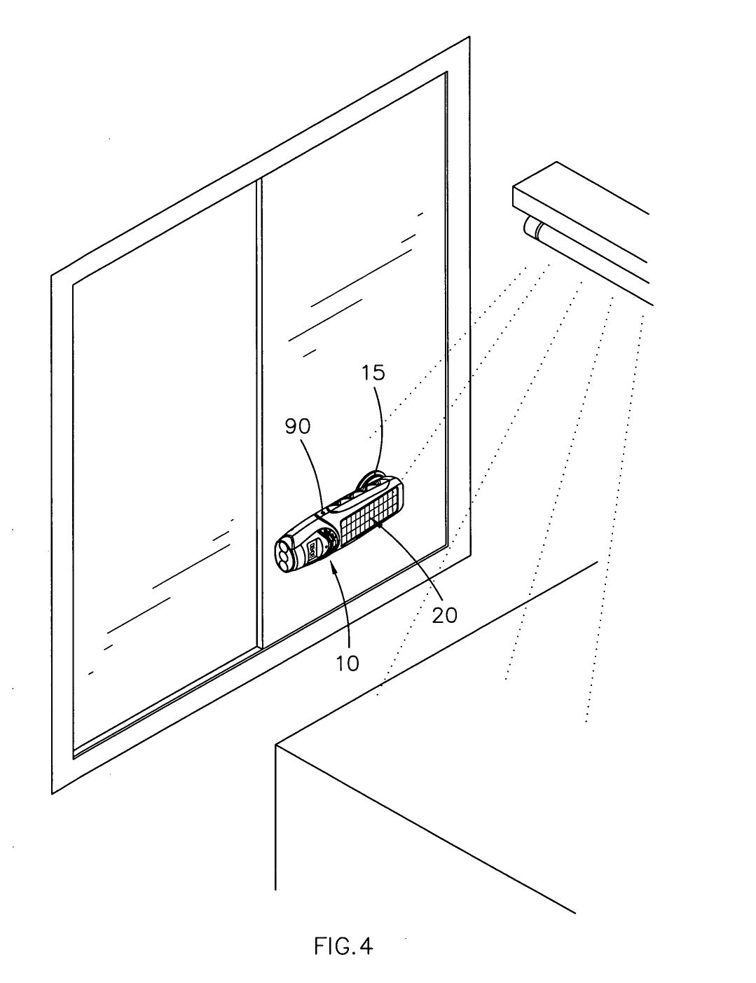

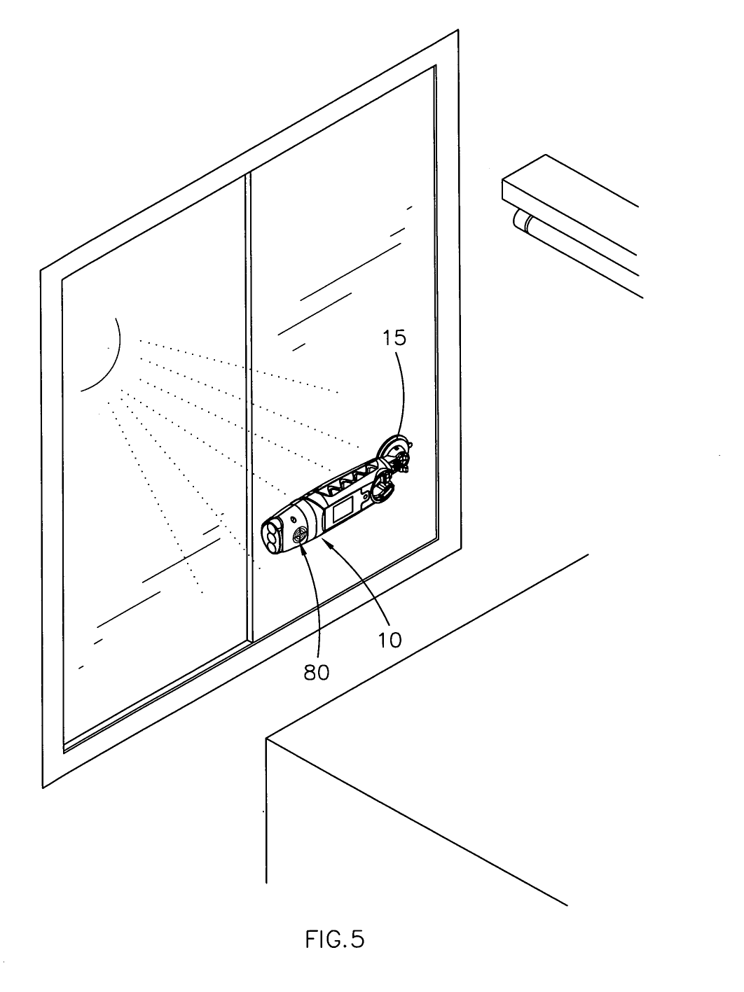

Referring to FIG. 4, the solar electric torch 10 is attached to a window of a room by the sucking element 15. Light is emitted from a light tube. The solar cells 20 are directed to the interior of the room. As the solar cells 20 are made of amorphous silicon, they can convert the light, which is emitted from the light tube, into electricity.

Referring to FIG. 5, the solar electric torch 10 is attached to the window of the room by the sucking element 15. Now, the light tube has been turned off. However, there is abundant sunlit. Hence, the solar electric torch 10 is pivoted from the position shown in FIG. 4 for 180 degrees so that the solar cells 20 are directed to the exterior of the room. The solar cells 20 convert the sunlit into electricity.

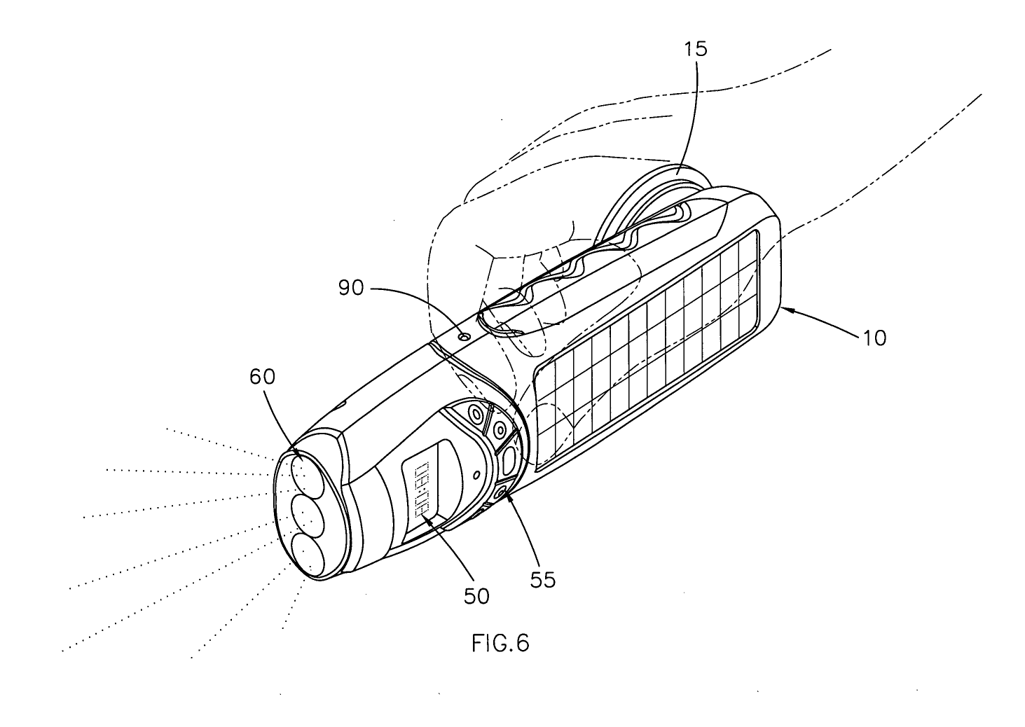

Referring to FIG. 6, light is emitted from the lighting unit 60. Other tasks can be conducted with the solar electric torch at the same time.

Because of the detector 35, the microprocessor 40 and the display 50, the user can learn the amount of the electricity stored in the rechargeable battery 30 and the recharging rate.

Because of the microprocessor 40, the control panel 55, the tuner 70 and the speaker 80, the user can listen to radio.

The microprocessor 40 may instruct the speaker 80 to provide a siren when the amount of the electricity stored in the rechargeable battery 30 reaches a lower limit.

The solar electric torch according to the present invention exhibits at least three advantages. Firstly, it is inexpensive. Secondly, it can be recharged indoor or anywhere there is dim light. Thirdly, it shows how much electricity is available.

The present invention has been described through the illustration of the preferred embodiment. Those skilled in the art can derive variations from the preferred embodiment without departing from the scope of the present invention. Therefore, the preferred embodiment shall not limit the scope of the present invention defined in the claims.

1. A solar electric torch comprising:
at least one solar cell made of amorphous silicon and provided thereon for converting light into electricity;
a rechargeable battery disposed therein for receiving the electricity from the solar cell and storing the same;
a regulator arranged between the solar cell and the rechargeable battery for stabilizing the recharging and avoiding the transfer of the electricity to the solar cell from the rechargeable battery;
a detector connected to the rechargeable battery for detecting the amount of the electricity stored in the rechargeable battery and a rate of the recharging;
a microprocessor connected to the detector;
a display mounted thereon and connected to the microprocessor for showing the amount of the electricity and the recharging rate; and
a lighting unit mounted thereon and connected to the microprocessor for illuminating.

2. The solar electric torch according to claim 1 comprising a control panel disposed thereon and connected to the microprocessor.

3. The solar electric torch according to claim 1 comprising a speaker connected to the microprocessor.

4. The solar electric torch according to claim 3 comprising a tuner connected to the microprocessor so that a user can listen to radio.

5. The solar electric torch according to claim 1 comprising a charger connected to the microprocessor for recharging another electric device.

6. The solar electric torch according to claim 1 wherein the display is a liquid crystal display.

7. The solar electric torch according to claim 1 wherein the display is a touch panel.

8. The solar electric torch according to claim 7 wherein the control panel is part of the touch panel.

9. The solar electric torch according to claim 1 comprising a sucking element connected thereto so that the solar electric torch can be attached to a plain surface by the sucking element.

10. The solar electric torch according to claim 9 wherein the sucking element is pivotally connected to the solar electric torch.
